(19) United States
(12) Patent Application Publication
(10) Pub. No.: US 2025/0130301 A1
(43) Pub. Date: Apr. 24, 2025

(54) DEVICE, METHOD, AND SYSTEM FOR DETERMINING ANGLE OF INCIDENCE

(71) Applicant: Infineon Technologies AG, Neubiberg (DE)

(72) Inventors: Mathias GANGL, Graz (AT); Walther PACHLER, Graz (AT); Dominic Peter PIRKER, Graz (AT)

(21) Appl. No.: 18/918,139

(22) Filed: Oct. 17, 2024

(30) Foreign Application Priority Data
Oct. 18, 2023 (DE) 102023128575.0

(51) Int. Cl. G01S 3/46

(52) U.S. Cl. CPC G01S 3/46

(57) ABSTRACT

Disclosed herein are devices, systems, and methods for determining an angle of incidence between one of two radio devices located at different locations and each having only a single antenna and a radio transmitter. The method includes exchanging radio signals between the first radio device and the second radio device to determine a distance between the first radio device and the second radio device, between the first radio device and the radio transmitter, and between the second radio device and the radio transmitter. The method also includes determining at least one angle of incidence (AoA) between at least one of the radio devices and the radio transmitter based on the exchanged radio signals.

### CROSS-REFERENCE TO RELATED APPLICATIONS

This patent application claims priority to German Patent Application No. 10 2023 128 575.0 filed on Oct. 18, 2023, the contents of which is fully incorporated herein by reference.

### TECHNICAL FIELD

The invention relates to a device and a method for operating a device.

### BACKGROUND

Applications that use UWB (Ultra Wide Band) radio signals for distance determination and localization are becoming increasingly numerous.

In addition, the so-called “angle of arrival” (AoA) is used in many cases, i.e. the angle at which a radio signal is incident on an antenna (also known as the angle of incidence).

For example, smart speakers may use AoA information and shape their emitted signal so that it is directed towards a target—e.g. a user (also known as beamforming)—and follows the user.

Alternatively, there are also many so-called “point and trigger” applications that use UWB to let devices interact with each other. For example, simple switching on and off.

Currently, measuring the AoA of a signal requires two or more antennas in a receiving device (e.g. in home automation devices such as speakers or lights, but also in devices worn on the body such as smartphones or headphones) in order to achieve technically feasible accuracy.

An exemplary use case for a first transceiver 104 and a second transceiver 102 is shown schematically in FIG. 1A.

The two antennas 106, 108 of the first UWB transceiver 104 may be used to determine the angle of incidence α (which may be measured relative to a line connecting the two antennas, for example) between the two transceivers 102, 104.

However, several difficulties arise in connection with the use of UWB with transceivers in devices that are significantly restricted in size.

For example, some devices (e.g. especially so-called in-ear or in-ear headphones, hereinafter referred to as in-ear headphones) may be so limited in size that it is not possible to accommodate two separate antennas at all, as the antenna distance depends on the frequency and cannot be reduced as desired.

In addition, due to the frequency dependence, the two antennas must be arranged within a certain physical distance to achieve the desired accuracy, which in turn requires larger dimensions of the device.

This physical distance depends on the frequency used and is therefore linked to a specific UWB channel. If a different channel is used than the one to which the antenna distance is tuned, the accuracy of the AoA measurement decreases again.

The ideal distance between the two antennas may be determined using the following equation, where λ is the wavelength of the radio waves:

$$d\_ideal = λ / 2$$

The table below shows antenna distances for different (frequency) channels that enable the highest accuracy to be achieved:

| Channel | Frequency (GHz) | d_ideal in mm |
|---|---|---|
| 5 | 6.5 | 23 |
| 6 | 7.0 | 21 |
| 8 | 7.5 | 19 |
| 9 | 8.0 | 18 |

In addition, the use of two antennas means that the current state of the art only covers a limited range of values. This range of values is between φ₁ and φ₂ (see the illustration in FIG. 1B). Exemplary tests have shown that, for example, only angles between approximately φ₁=−50° and approximately φ₂=+50° may be measured. Outside this value range, the measurement errors may be so large—for example, more than 40% and/or an offset to the true value—that the determined values are too unreliable to be technically usable, because in real use it would only be possible to ensure that only this specified value range occurs in very few cases.

The limitation of antenna spacing in terms of angular range is perhaps the biggest problem when integrating UWB-based angle measurement into devices such as headphones. Especially with in-ear headphones, there are few possible arrangements to position the two antennas at the required distance from each other: For example, in a shank extending outside the ear in a vertical direction.

The AoA calculation would only work reliably if the UWB transmitter (e.g. a smartphone or its longitudinal axis) is located within the angular limits φ₁ and φ₂ (see the illustration in FIG. 1B). These angular limits are related to an imaginary connecting line (also referred to as the AoA plane) between the antennas (see FIG. 1B).

In a typical use case, however, the headphones (or the AoA plane) and UWB transmitter (e.g. smartphone, or its longitudinal axis) would probably be aligned parallel to each other, because both the headphone shank and the smartphone are typically used in a vertical arrangement, e.g. when the user is standing or sitting and holding the smartphone in their hand.

With the more realistic relative positioning of transmitter and receiver, the optimum antenna positioning would be one whose AoA plane is horizontal (e.g. perpendicular to the direction of gravity). However, there is no room for this, especially in in-ear headphones, or the necessary distance between the antennas cannot be achieved.

There are also proposals to use a channel impulse response (CIR), or more precisely the multiple path information of the CIR, to determine the AoA.

This is described, for example, in the article “Angle of Arrival Estimation based on Channel Impulse Response Measurements” by Anton Ledergerber, Michael Hamer and Raffaello D′Andrea (https://ethz.ch/content/dam/ethz/special-interest/mavt/dynamic-systems-n-control/idsc-dam/People/antonl/iros19.pdf). According to the authors, they achieve an error of less than 25° with a probability of over 90%. In real applications, an accuracy of less than 25° is probably required.

Accordingly, there may be a need to determine an AoA in a device with high accuracy, even in a case where each of the individual elements comprises only a small form factor, e.g. in-ear headphones.

### SUMMARY

In various embodiments, a device is provided comprising a first radio device with a (single) first antenna and a second radio device with a (single) second antenna, wherein the first radio device and the second radio device are configured to exchange radio signals with each other and with a radio transmitter, and wherein at least one of the radio devices is configured to determine an angle of incidence (AoA) between at least one of the radio devices on the one hand and the radio transmitter on the other hand based on the exchanged radio signals or to receive the angle of incidence determined by the radio transmitter.

In other words, the device comprises two radio devices, each comprising (only) one antenna and exchanging radio signals with an external radio transmitter (for example by at least one processor or controller cooperatively operating both antennas). Based on the exchanged radio signals, at least one angle of incidence (AoA) between at least one of the radio devices and the radio transmitter may be determined. The angle of incidence (AoA) is also referred to as 2D AoA, in contrast to 3D AoA, which describes a relative position of the radio device and radio transmitter in the chamber by two angles. In order to measure the 3D AoA, a third radio device would be required, which would be positioned on the third axis, spatially moved in relation to the other two radio devices. The third axis is perpendicular to the plane spanned by the two other radio devices.

Referring to a method for determining an angle of incidence between two radio devices, each having only one antenna, and a radio transmitter, this means that the two radio devices exchange radio signals with the radio transmitter and with each other and at least one angle of incidence (AoA) between at least one of the radio devices and the radio transmitter is determined on the basis of the exchanged radio signals.

A special embodiment for measuring an AoA signal is provided by UWB-capable devices that are already available in multiple versions as a system. An example of devices or transceivers that may form a system in pairs are headphones, for example in-ear headphones.

According to other examples, instead of (or in addition to) headphones, the device may comprise any other set of radio devices whose function requires a combination of two or more radio devices, or where the set of radio devices is at least typically operated simultaneously and in spatial proximity (e.g. in the same chamber), such as a speaker and a lamp.

With various embodiments of the device or method disclosed herein, a size of the device may be significantly reduced because the distance between the two antennas does not need to be realized within the dimensions of each individual radio device, but is provided by the distance between the two radio devices (which are cooperatively operated).

In addition, various embodiments make it possible to significantly reduce a measurement error when determining the angle of incidence AoA compared to the prior art. In particular, the permissible range of values is not limited (e.g. as described above to the angle range from −50° to)+50°, which significantly improves the user experience.

Furthermore, according to various embodiments, a special geometric arrangement of the device in relation to the radio transmitter is unnecessary.

### BRIEF DESCRIPTION OF THE DRAWINGS

The figures and following description provide examples and/or embodiments that may further illustrate and explain aspects of the nature of the disclosure with reference to the following figures in which:

FIG. 1A shows a schematic representation of a prior art device;

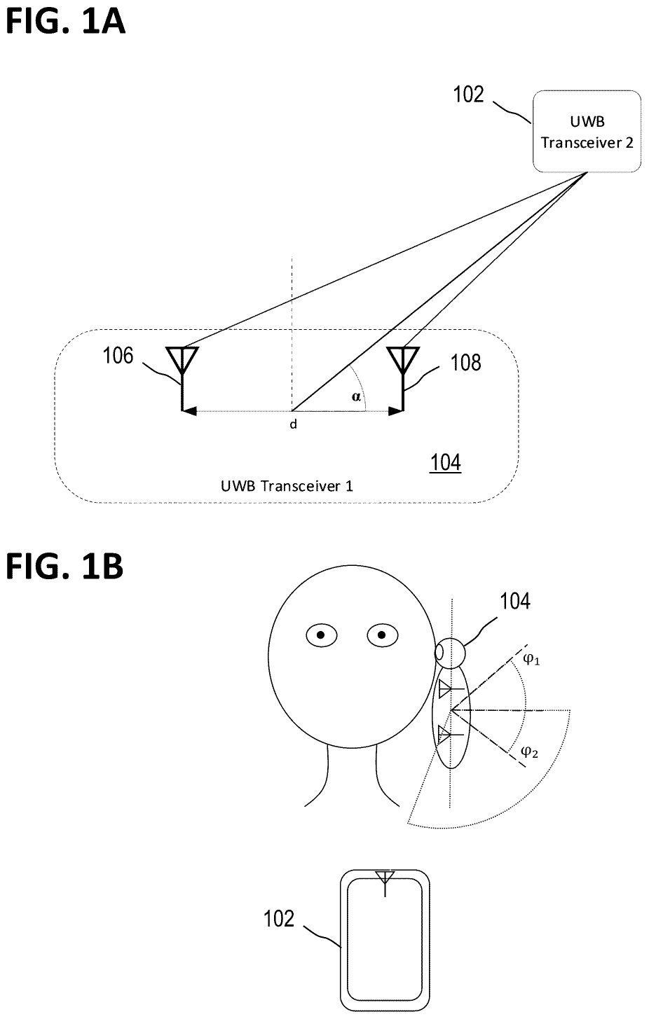

FIG. 1B shows illustration of angular limits of the prior art device of FIG. 1A;

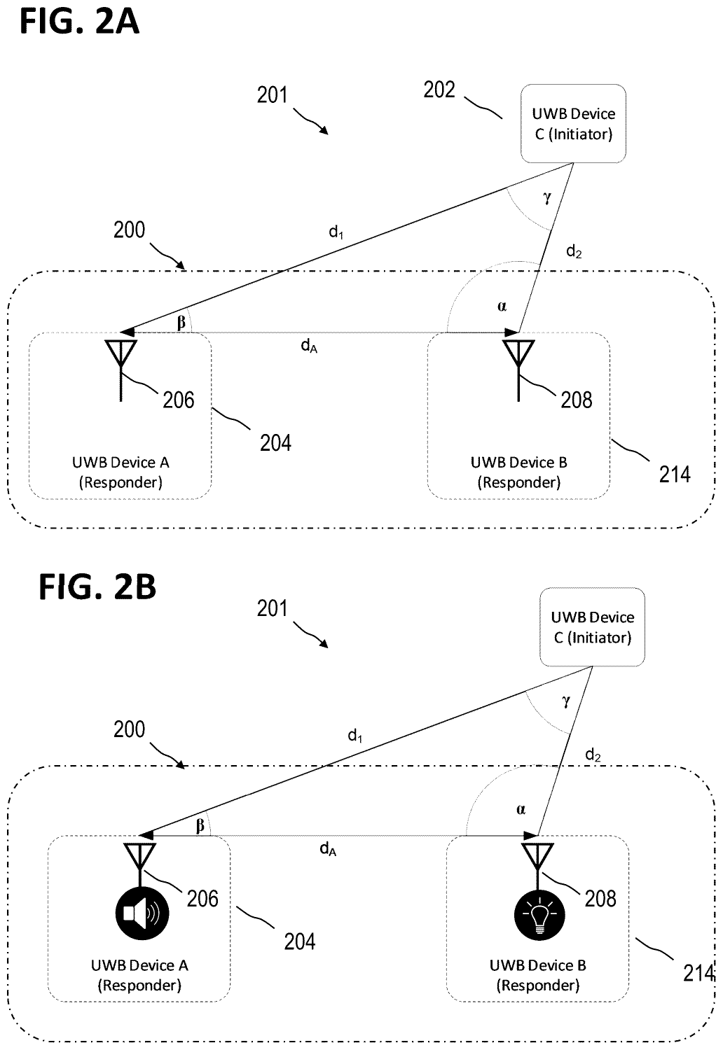

FIG. 2A to 2D each show a schematic representation of a device according to various embodiments;

FIG. 3 shows a schematic representation of a method for determining an angle of incidence according to various embodiments; and

FIG. 4 shows a flowchart of a method for determining an angle of incidence according to various embodiments.

### DESCRIPTION

In the following detailed description, reference is made to the accompanying drawings which form part thereof and in which specific embodiments in which the invention may be practiced are shown for illustrative purposes. In this regard, directional terminology such as “top”, “bottom”, “front”, “rear”, “forward”, “rearward”, etc. is used with reference to the orientation of the figure(s) described. Since components of embodiments may be positioned in a number of different orientations, the directional terminology is for illustrative purposes and is not limiting in any way. It is understood that other embodiments may be used and structural or logical changes may be made without departing from the scope of protection of the present invention. It is to be understood that the features of the various exemplary embodiments described herein may be combined with each other, unless specifically indicated otherwise. The following detailed description is therefore not to be construed in a limiting sense, and the scope of protection of the present invention is defined by the appended claims.

In the context of this description, the terms “connected”, “attached” and “coupled” are used to describe both a direct and an indirect connection, a direct or indirect attachment and a direct or indirect coupling. In the figures, identical or similar elements are provided with identical reference signs where this is appropriate.

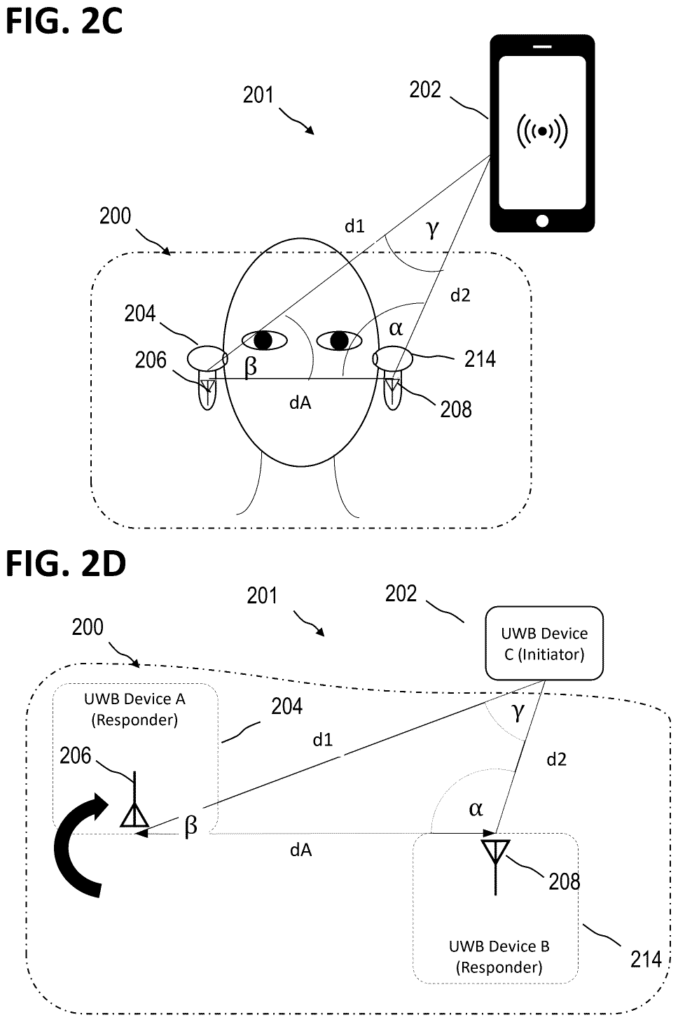

FIGS. 2A to 2D each show a schematic representation of a device 200 according to different embodiments.

The device 200 comprises a first radio device 204 having a single first antenna 206 and a second radio device 214 having a single second antenna 208. The first radio device 204 and the second radio device 214 are also collectively referred to as “the radio devices”.

The first radio device 204 and the second radio device 214 are each configured to exchange radio signals with an external radio transmitter 202.

In various embodiments, the radio devices 204, 214 may be configured for ultra-wideband (UWB) communication. For example, the antennas 206, 208 may be suitable for receiving and transmitting radio signals in a frequency range between about 3.1 GHz and about 10.6 GHz.

Further, the device, for example the first radio device 204 and/or the second radio device 214, may comprise a processor or controller which may be configured to operate the antennas 206 and/or the antenna 208.

The first radio device 204 and the second radio device 214 are spatially separated from each other. This means that the first antenna 206 and the second antenna 208 are not integrally formed, for example are not arranged in a common housing.

For example, embodiments of the device 200 comprise a set of headphones, for example in-ear headphones typically comprising physically completely separate left ear and right ear units, or for example capsule wireless headphones comprising a capsule for each ear to be worn over the ear and typically connected together by means of a bridge. There, each of the antennas may be arranged in one of the capsules, wherein the two capsules are not integrally formed, but are merely connected by means of the bridge. The headphone example is illustrated in FIG. 2C.

Further, the device 200 may comprise two (or more, as will be described below the device or method is extensible to more than two radio devices) substantially any radio devices 204, 214, both of which are within radio range of the radio transmitter 202 and typically used simultaneously or at least activatable. This is illustrated in FIG. 2B for a device 200 comprising a speaker as the first radio device 204 and a lamp as the second radio device 214.

A combination of the device 200 and the radio transmitter 202 forms a (radio) system 201.

The device 200 may be configured to determine at least one angle of incidence (AoA) between at least one of the radio devices 204, 214 and the radio transmitter 202 based on the exchanged radio signals.

In FIGS. 2A to 2D, the angle of incidence AoA between the first radio device 204 and the radio transmitter 202 is labeled a, and the angle of incidence AoA between the second radio device 214 and the radio transmitter 202 is labeled B.

In various embodiments, the first radio device 204 and the second radio device 214 are further configured to exchange radio signals with each other.

According to various embodiments, the angle of incidence AoA is determined in cooperation between the first radio device 204 and the second radio device 214. This means that information determined in or by means of the first radio device 204 is also provided to the second radio device 214, and vice versa. Whether the information is provided by means of direct communication between the first radio device 204 and the second radio device 214 or indirectly by means of the radio transmitter 202 is of secondary importance and may be configured depending on the technical requirements.

The device 200 is further configured to determine a distance between the first radio device 204 and the radio transmitter 202 and between the second radio device 214 and the radio transmitter 202 as a basis for determining the angle of incidence.

Determining a distance between two participating communication partners is regularly carried out in UWB radio communication according to the prior art and may be carried out in a similar or identical manner in various embodiments.

According to various embodiments, the distance between the first radio device 204 and the second radio device 214 is required to determine the angle of incidence. This is because if all three distances (designated in the figures as d1 for the distance between the first radio device 204 and the radio transmitter 202, d2 for the distance between the second radio device 214 and the radio transmitter 202, and dA for the distance between the first radio device 204 and the second radio device 214) of the radio devices 204, 214 and the radio transmitter 202 arranged in a triangle are known, all angles—and accordingly also the angles of incidence α and β—may be calculated by means of the cosine theorem:

$${a}^{2} = {b}^{2} + {c}^{2} - 2 \cdot b \cdot c \cdot cos ( α ) \\ {b}^{2} = {a}^{2} + {c}^{2} - 2 \cdot a \cdot c \cdot cos ( β ) \\ {c}^{2} = {a}^{2} + {b}^{2} - 2 \cdot a \cdot b \cdot cos ( γ )$$

Rearranged to determine the angles and applied to the illustration in FIG. 2A to 2D:

$$α = arccos ( ( {d}_{2}^{2} + {d}_{A}^{2} - {d}_{1}^{2} ) / ( 2 {d}_{2} {d}_{A} ) ) \\ β = arccos ( ( {d}_{1}^{2} + {d}_{A}^{2} - {d}_{2}^{2} ) / ( 2 {d}_{1} {d}_{A} ) )$$

According to various embodiments, the distance between the first radio device 204 and the second radio device 214 may be determined (dynamically, currently). This may be useful, for example, for radio devices 204, 214 such as speakers, mobile lamps or the like.

To determine the distance dA between the first radio device 204 and the second radio device 214, each of the first radio device 204 and the second radio device 214 separately performs a distance determination (also referred to as a “ranging session”).

In addition, the distances d1 or d2 may be added as a proprietary payload to the messages used for distance measurement. For example, when determining the distance for d₁, which is carried out by means of a communication between the first radio device 204 and the radio transmitter 202, the distance d₂ may be added to the communication as a payload.

Conversely, when determining the distance for d₂, which is carried out by means of communication between the second radio device 214 and the radio transmitter 202, the distance d₁ may be added to the communication as a payload.

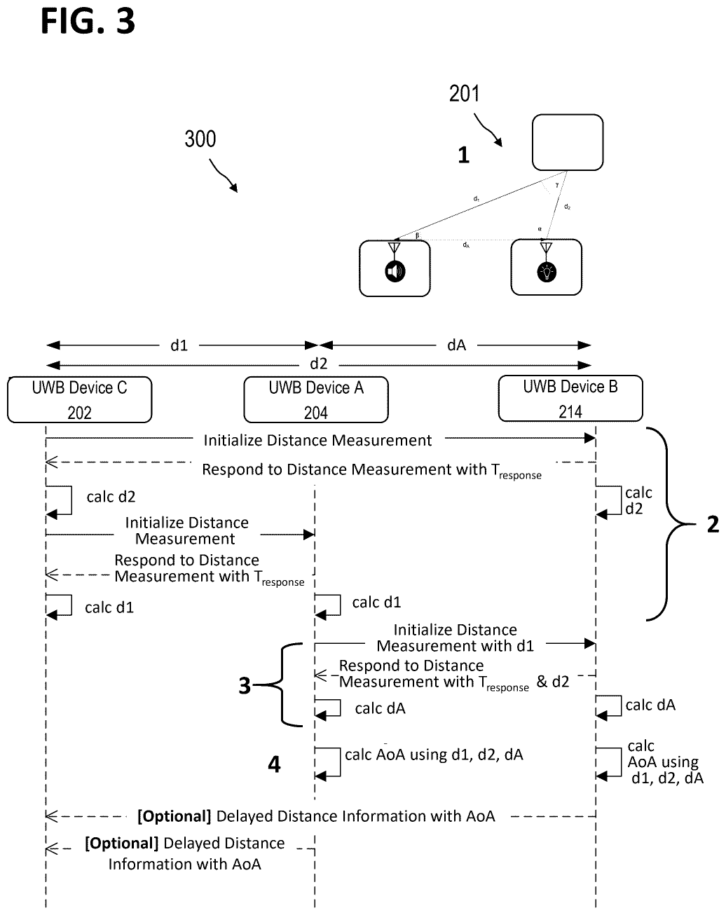

FIG. 3 is a schematic, simplified representation of a method for determining an angle of incidence according to various embodiments.

For the method, for example, the device 200 or system 201 explained in connection with FIGS. 2A to 2D may be used (this is marked “1” in FIG. 3 and merely symbolizes the representation of FIG. 2A, so that it is not necessary to be able to read the designations therein).

The simplified representation of FIG. 3 shows the radio signals or messages exchanged between the first radio device 204, the second radio device 214 and the radio transmitter 202.

In the dynamic split AoA mode, the first radio device 204 and the second radio device 214 may be configured to realize the same.

In other words, it is sufficient if (e.g., on the factory or user side) only the first radio device 204 and the second radio device 214 are configured to perform the dynamic split AoA mode. For the radio transmitter 202, the dynamic split AoA mode may be transparent or substantially transparent because it (e.g., its processor or controller) only needs to be configured to perform the distance measurement to the first radio device 204 and the second radio device 214 as usual.

In FIG. 3, “2” indicates that the radio transmitter 202 (the UWB device C) initiates distance measurements to both the first radio device 204 (the UWB device A) and the second radio device 214 (the UWB device B).

First, radio signals are sent from the radio transmitter 202 to the second radio device 214 to initiate the distance measurement, the response from the second radio device 214 requires the time Tᵣₑₛₚₒₙₛₑ to arrive at the radio transmitter 202, and from this, in this example, both the radio transmitter 202 and the second radio device 214 calculate the distance d₂, wherein a message containing Tᵣₑₛₚₒₙₛₑ is omitted here for the sake of simplicity. Alternatively, the calculation may take place only in the radio transmitter 202 and be transmitted to the second radio device 214 as a radio signal, or be transmitted only in the second radio device 214 and the radio transmitter 202.

Subsequently, radio signals are sent from the radio transmitter 202 to the first radio device 204 to initiate the distance measurement, the response from the first radio device 204 requires the time Tᵣₑₛₚₒₙₛₑ to arrive at the radio transmitter 202, and from this, in this example, both the radio transmitter 202 and the first radio device 204 calculate the distance d₁, wherein a message containing Tᵣₑₛₚₒₙₛₑ is omitted here for the sake of simplicity. Alternatively, the calculation may take place only in the radio transmitter 202 and be transmitted to the first radio device 204 as a radio signal, or only in the first radio device 204.

Subsequently, as indicated by “3”, the second radio device 214 may initiate a distance measurement with the first radio device 204, for which purpose radio signals are transmitted from the second radio device 214 to the first radio device 204. The response from the first radio device 204 requires the time Tᵣₑₛₚₒₙₛₑ to arrive at the first radio device 204, and from this, in this example, both the second radio device 214 and the first radio device 204 calculate the distance d_{A}, wherein a message containing Tᵣₑₛₚₒₙₛₑ is omitted here for the sake of simplicity. Alternatively, the calculation may take place only in the second radio device 214 and be transmitted to the first radio device 204 as a radio signal, or be transmitted only in the first radio device 204 and the second radio device 214.

The AoA angles α and β are then calculated (marked “4” in FIG. 3) in the first radio device 204 and the second radio device 214, respectively.

The three previously determined distances d1, d2 and dA are used and the cosine theorem is applied as above.

The first radio device 204 and the second radio device 214 may thereby calculate the two angles of incidence α and β and the angle γ at the radio transmitter 202, or only one or both angles of incidence α and β, or any other reasonable combination, and transmit a result to the other radio device 204 or 214 as appropriate.

Optionally, the first radio device 204 and/or the second radio device 214 may transmit the angles of incidence to the radio transmitter 202 (labeled [Optional] in FIG. 3).

Alternatively, if the radio transmitter 202 is configured to do so, the angle calculation may be performed in the radio transmitter 202 and the result transmitted to the first radio device 204 and/or the second radio device 214 as a radio signal.

The so-called “Deferred Mode” may be used for transmission, which is described in IEEE 802.15.4z-2020 in chapter 6.9.6 “Ranging procedures”.

In general, all communication may take place within the framework of established standards, for example defined UCI notifications.

According to various embodiments, the first radio device 204 and the second radio device 214 may be a fixed (i.e. constant) distance apart, at least during use. Examples include headphones that are always at a distance corresponding to a head diameter during use.

In such a case, it may be sufficient if the distance d_{A} between the first radio device 204 and the second radio device 214 is determined only once, for example when the device 200 is put into operation. Subsequently, for example during further operation, it may be sufficient if only the distance d₁ between the first radio device 204 and the radio transmitter 202 and the distance d₂ between the second radio device 214 and the radio transmitter 202 are determined dynamically (for example at regular time intervals).

In cases (FIG. 2D shows a corresponding example) where the radio transmitters 204, 214 do not allow a corresponding information to be determined directly because one or both devices are rotatable about the axis connecting the two radio devices 204, 214 and their function is asymmetrical with respect to the axis of connection (e.g. in the case of a lamp or a speaker), the direction may be determined by rotating the radio device 204 or 214 about the connecting axis and requesting feedback from the user (e.g. by means of the radio device 204 or 214 or by means of the radio transmitter 202) in order to determine a correct position of use and to calibrate the determined angles of incidence.

According to various embodiments, the distance between the two radio devices 204, 214 may be in a region of about +/−10% of a half-wavelength of the radio signals.

The determining of the at least one angle of incidence may be performed in one of the radio devices 204, 214, for example by means of the respective processor or controller, or for example in the radio transmitter 202 (e.g. in its processor or controller).

The method on which the angle of incidence is determined may also be referred to as “dynamic split AoA mode”.

In various embodiments, the accuracy of an angle of incidence measurement (or the angle γ, which corresponds to the angles α and β) is increased compared to the prior art.

The maximum error is based solely on the accuracy of the distance measurement.

Assuming that the distances may each be determined with an accuracy of 0.1 m, the maximum error of the angle γ for respective distances d₁, d₂ and d_{A} of 4 m would be around 3.3°, and for distances d₁, d₂ and d_{A} of 0.5 m around 26.5°.

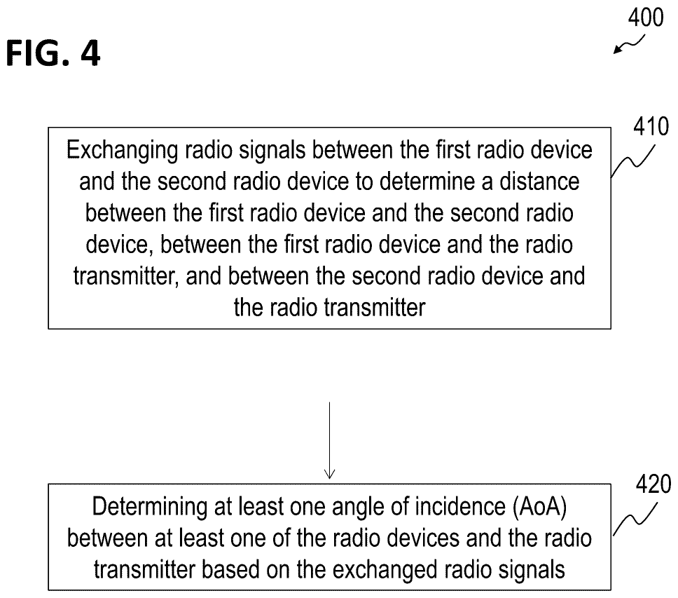

FIG. 4 shows a flowchart 400 of a method for determining an angle of incidence according to various embodiments.

The angle of incidence to be determined is between one of two radio devices located at different locations, each comprising a single antenna, and a radio transmitter.

The method comprising exchanging radio signals between the first radio device and the second radio device to determine a distance between the first radio device and the second radio device, between the first radio device and the radio transmitter, and between the second radio device and the radio transmitter (in 410), and determining at least one angle of incidence (AoA) between at least one of the radio device and the radio transmitter based on the exchanged radio signals (in 420).

Some examples of the disclosed angle of instance determination are summarized below. The examples provided in relation to the devices may apply also to the described method(s), and vice versa.

Example 1 is a method for determining an angle of incidence between one of two radio devices located at different locations and each having only a single antenna, and a radio transmitter. The method comprises exchanging radio signals between the first radio device and the second radio device to determine a distance between the first radio device and the second radio device, between the first radio device and the radio transmitter, and between the second radio device and the radio transmitter, and determining at least one angle of incidence (AoA) between at least one of the radio devices and the radio transmitter based on the exchanged radio signals.

Example 2 is a method according to example 1, which further comprises determining a distance between the first radio device and the radio transmitter and between the second radio device and the radio transmitter as a basis for determining the angle of incidence.

Example 3 is a method according to example 1 or 2, wherein the radio signals are UWB signals or comprise UWB signals.

Example 4 is a method according to any one of examples 1 to 3, wherein determining the at least one angle of incidence comprises determining the respective angle of incidence between each of the two radio devices and the radio transmitter.

Example 5 is a method according to one of examples 1 to 4, wherein the determining of the at least one angle of incidence is carried out in one of the radio devices.

Example 6 is a method according to one of examples 1 to 5, wherein the determining of the at least one angle of incidence takes place in the radio transmitter.

Example 7 is a method according to any one of examples 1 to 6, wherein a distance between the two radio devices is in a region of about +/−10% of a half-wavelength of the radio signals.

Example 8, is a device comprising a first radio device with a single first antenna and a second radio device, which is located at a different location from the first radio device, with a single second antenna, wherein the first radio device and the second radio device are each configured to exchange radio signals with each other to determine a distance between the first radio device and the second radio device, to exchange radio signals with an external radio transmitter, and to determine at least one angle of arrival (AoA) between at least one of the radio devices and the radio transmitter from the exchanged radio signals.

Example 9 is a device according to Example 8, which is further configured to determine a distance between the first radio device and the radio transmitter and between the second radio device and the radio transmitter as a basis for determining the angle of incidence.

Example 10 is a device according to example 8 or 9, wherein the first radio device comprises a first headphone and the second radio device comprises a second headphone.

Example 11 is a device according to any one of examples 8 to 10, wherein the radio signals are UWB signals or comprise UWB signals.

Example 12 is a device according to one of examples 8 to 11, wherein the determining of the at least one angle of incidence takes place in one of the radio devices.

Example 13 is a device according to one of examples 8 to 12, wherein the determining of the at least one angle of incidence takes place in the radio transmitter.

Example 14 is a device according to one of examples 8 to 13, wherein a distance between the two radio devices is in a region of about +/−10% of a half-wavelength of the radio signals.

Example 15 is a device according to any one of examples 8 to 14, wherein a distance between the two radio devices corresponds to an average distance between two ears of a user.

Example 16 is a device according to one of examples 8 to 15, which further comprises a processor or controller which is configured to carry out the determining of the angle of incidence.

Example 17 is a device according to example 16, wherein the processor or controller is part of the first radio device and/or part of the second radio device.

Example 18 is a system comprising a device according to any one of examples 8 to 17 and the radio transmitter.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

1. A method of determining an angle of incidence between a radio transmitter and one of two radio devices located at different locations and each having only a single antenna, the method comprising:
exchanging a first set of radio signals between a first radio device of the two radio devices and a second radio device of the two radio devices to determine a distance between the first radio device and the second radio device;
exchanging a second set of radio signals between the first radio device and the radio transmitter and between the second radio device and the radio transmitter; and
determining an angle of incidence (AoA) between the radio transmitter and the one of the two radio devices based on the first and second set of exchanged radio signals.

2. The method according to claim 1, the method further comprising:
determining the angle of incidence based on a first distance that is between the first radio device and the radio transmitter and based on a second distance that is between the second radio device and the radio transmitter.

3. The method according to claim 1, wherein the determining the angle of incidence comprises determining a first angle of incidence as between the radio transmitter and the first radio device and determining a second angle of incidence as between the radio transmitter and the second radio device.

4. The method according to claim 1, wherein the radio signals are ultra-wide band (UWB) signals or comprise UWB signals.

5. The method according to claim 1, wherein the angle of incidence is determined in the radio transmitter.

6. The method according to claim 1, wherein the distance between the two radio devices is about +/−10% of a half-wavelength of the radio signals.

7. A device comprising:
a first radio device having a single first antenna; and
a second radio device, located at a different location from the first radio device, the second radio device having a single second antenna, wherein the first radio device and the second radio device are each configured to:
exchange first radio signals with each other to determine a distance between the first radio device and the second radio device;
exchange second radio signals with an external radio transmitter; and
determine an angle of incidence (AoA) as between at least one of the radio devices and the radio transmitter based on the first radio signals and the second radio signals.

8. The device according to claim 7, the device further configured to determine a first distance between the first radio device and the radio transmitter and determine a second distance between the second radio device and the radio transmitter, wherein the angle of incidence is further based on the first distance and the second distance.

9. The device according to claim 7, wherein the first radio device comprises a first headphone and the second radio device comprises a second headphone.

10. The device according to claim 7, wherein the radio signals are ultra-wideband (UWB) signals or comprise UWB signals.

11. The device according to claim 7, wherein the distance between the two radio devices is about +/−10% of a half-wavelength of the radio signals.

12. The device according to claim 7, wherein the distance between the two radio devices corresponds to an average distance between two ears of a user.

13. The device according to claim 7, wherein each of the first radio device and the second radio device comprise a processor configured to determine of the angle of incidence.

14. The device according to claim 13, wherein either the first radio device or the second radio device comprises a processor configured to determine of the angle of incidence.

15. A system comprising:
a radio transmitter;
a first radio device having a single first antenna; and
a second radio device associated with the first radio device, wherein the second radio device is located at a different location from the first radio device, the second radio device having a single second antenna, wherein the first radio device and the second radio device are each configured to:
exchange radio signals with each other to determine a distance between the first radio device and the second radio device; and
exchange radio signals with the radio transmitter,
wherein a selected device of the first radio device, the second radio device, or the radio transmitter is configured to determine an angle of incidence (AoA) as between the radio transmitter and one of the first and second radio devices based on the exchanged radio signals.

16. The system according to claim 15, wherein the angle of incidence is further based on a first distance that is between the first radio device and the radio transmitter and further based on a second distance that is between the second radio device and the radio transmitter.

17. The system according to claim 15, wherein the selected device configured to determine the AoA comprises the selected one configured to determine a first angle of incidence as between the radio transmitter and the first radio device and to determine a second angle of incidence as between the radio transmitter and the second radio device.

18. The system according to claim 15, wherein the radio signals are ultra-wide band (UWB) signals or comprise UWB signals.

19. The system according to claim 15, wherein the first radio device comprises a first headphone and the second radio device comprises a second headphone.

20. The system according to claim 15, wherein the distance between the two radio devices is about +/−10% of a half-wavelength of the radio signals.
